(19) United States
(12) Patent Application Publication
(10) Pub. No.: US 2013/0129525 A1
(43) Pub. Date: May 23, 2013

(54) WIND POWER PLANT FOR PRODUCING ELECTRIC ENERGY, AND RELATIVE PYLON CONSTRUCTION METHOD

(71) Applicant: Otto Pabst, Rio Di Pusteria (IT)

(72) Inventor: Otto Pabst, Rio Di Pusteria (IT)

(73) Assignee: WILIC S.AR.L., Luxembourg (LU)

(21) Appl. No.: 13/510,235

(22) PCT Filed: Nov. 15, 2010
(86) PCT No.: PCT/EP2010/067431

§ 371 Date: Jul. 24, 2012

(30) Foreign Application Priority Data
Nov. 16, 2009 (IT) MI 2009 A 002007

(51) Int. Cl. F03D 9/00

(52) U.S. Cl. CPC F03D 9/002
USPC 416/244 R

(57) ABSTRACT

A wind power plant configured to produce electric energy has a foundation; a pylon extending along an axis; an electric generator mounted on top of the pylon; and a blade assembly which rotates with respect to the generator; the pylon having a portion made of flat, reinforced-concrete panels assembled such that the portion has a polygonal cross section.

### PRIORITY CLAIM

This application is a national stage application of PCT/EP2010/067431, filed on Nov. 15, 2010, which claims the benefit of and priority to Italian Patent Application No. MI2009A 002007, filed on Nov. 16, 2009, the entire contents of which are incorporated herein.

### BACKGROUND

The technique of constructing pylons from panels is one technique normally used for exceptionally large pylons that are difficult to transport and handle. The following documents relate to wind power plants comprising pylons made from panels:
(1) German Patent No. 10 2007 018 025 A1 relates to a wind power plant comprising a truncated-cone- or truncated-pyramid-shaped pylon made of curved or angled steel panels.
(2) German Patent No. 20 2006 009 554 U1 and European Patent No. 1 262 614 A2 relate to wind power plant pylons made partly of reinforced concrete and partly of steel.
(3) European Patent. No. 1 876 316 A1, Japanese Patent No. 2008 101363 A, Japanese Patent No. 2009 57713 A, U.S. Published Patent Application No. 2006/0272244 Al, U.S. Published Patent Application No. 2007/0294955 A1, U.S. Published Patent Application No. 2005/0129504, PCT Patent Application No. 2008/110309 A2, and PCT Patent Application No. 2009/056898 A1 relate to wind power plant pylons made of steel or reinforced-concrete panels.

On the one hand, the relatively smaller the panels, the relatively lighter the panels are, they are easier to handle and transport, and can be made in modular or standard sizes, regardless of the upward-tapering cross section of the pylon. On the other hand, relatively small panels involve a large quantity of joints, which must be made on site by skilled workmen working at considerable heights, and must be checked cyclically for safety reasons. Consequently, one solution is to use relatively large panels to reduce the quantity of joints, but not large or heavy enough to make them difficult to transport or handle.

In the case of high-power plants with exceptionally heavy generators, one known practice is to construct pylons in which at least the bottom portion (i.e., the portion resting directly on the foundation), is made of prefabricated reinforced-concrete panels, which are lighter than corresponding steel portions.

### SUMMARY

The present disclosure relates to a wind power plant configured to produce electric energy.

More specifically, the present disclosure relates to a wind power plant comprising a reinforced-concrete foundation; a pylon extending along a vertical axis and comprising at least one portion made of panels assembled to one another on site; an electric generator mounted on top of the pylon; and a blade assembly configured to drive the generator.

It is one advantage of the present disclosure to provide a wind power plant comprising a pylon which is relatively easy to construct and, at the same time, structurally strong.

Another advantage of the present disclosure to provide a wind power plant comprising a pylon made at least partly of assembled panels that are relatively easy to produce, and the size of which can be altered relatively easily when necessary.

According to the present disclosure, there is provided a wind power plant configured to produce electric energy, the wind power plant comprising a foundation; a pylon extending along a designated axis; an electric generator mounted on top of the pylon; and a blade assembly configured to drive the generator; the pylon comprising at least one portion made of flat, reinforced-concrete, adjacent panels assembled so the portion has a polygonal cross section, wherein each panel comprises an outer face, an inner face, and two lateral faces, is fixed by the lateral faces to the adjacent panels, and comprises a main body of reinforced concrete; and lateral plates integral with the main body and at least partly defining the lateral faces of the panel. In one embodiment, the lateral plates define the whole of the lateral faces of the panel.

In one embodiment, using only flat, reinforced-concrete panels, as opposed to curved or angled panels, the panels can be made using a vibrating machine, with no need for complex molds; the size of the panels can be altered easily when necessary; and, being relatively simple in shape, the panels can even be produced at the wind power system erection site.

In one embodiment of the present disclosure, each panel is in the form of an isosceles trapezium, the height of which is greater than its mean width; said height being at least three times, and in one embodiment, six times, the mean width.

Relatively long panels can thus be produced, to construct long pylon portions and so speed up construction of the pylon as a whole and reduce the quantity of joints.

Another advantage of the present disclosure is to provide a straightforward, low-cost method of constructing a wind power plant pylon.

According to the present disclosure, there is provided a method of constructing a pylon of a wind power plant, wherein the wind power plant comprises a foundation; the pylon, which extends along a designated axis; an electric generator mounted on top of the pylon; and a blade assembly configured to drive the generator; the pylon comprising at least one portion made of flat, reinforced-concrete, adjacent panels assembled so the portion has a polygonal cross section; and the method comprising the steps of:
(i) pouring concrete into a mold at least partly forming an integral part of said panel;
(ii) producing a quantity of panels as in step (i);
(iii) arranging said quantity of panels about the axis, so each panel is adjacent to two panels;
(iv) joining the adjacent panels,
   wherein the mold is defined by a table of a vibrating machine, by lateral plates, by a top plate, and by a bottom plate; the lateral plates, the top plate, and the bottom plate being joined to the main body and forming an integral part of the panel.

Construction of the pylon portion is thus relatively easier, and can be carried out, in one embodiment, even entirely on site.

The molds are thus relatively easy to make and, above all, the plates perform important functions within the panel: the lateral plates define the lateral mating faces and connecting portions of adjacent panels, and impart flexural strength to the panel even before it is stressed; and the top and bottom plates define the top and bottom mating faces of the panel, and serve to distribute compressive stress evenly in the main body.

In one embodiment of the present disclosure, the method comprises the step of lifting each panel from a substantially horizontal position to a substantially vertical position using a structure hinged to the foundation and configured to house the panel.

Unlike methods in which panels are lifted using a crane, the panel is thus guided into position by a structure that prevents it from oscillating, thus making the job relatively safer, reducing the risk of damage to the panel, while at the same time positioning the panel relatively faster and so speeding up construction of the pylon as a whole.

Additional features and advantages are described in, and will be apparent from the following Detailed Description and the figures.

### BRIEF DESCRIPTION OF THE DRAWINGS

A non-limiting embodiment of the present disclosure will be described by way of example with reference to the accompanying drawings, in which:

FIG. 1 shows a side view, with parts removed for clarity, of a wind power plant in accordance with the present disclosure;

FIG. 2 shows a plan view, with parts removed for clarity, of a detail of FIG. 1;

FIG. 3 shows a cross section, with parts removed for clarity, along line of the FIG. 1 plant;

FIG. 4 shows a larger-scale detail of the FIG. 3 cross section;

FIGS. 5 and 6 show larger-scale sections, with parts removed for clarity, of a detail of the FIG. 1 plant in two different planes;

FIG. 7 shows a view in perspective of a panel during construction and positioned on a vibrating machine in accordance with the method according to the present disclosure; and

FIGS. 8 and 9 show two sections of respective steps in assembling a panel in accordance with the method according to the present disclosure.

### DETAILED DESCRIPTION

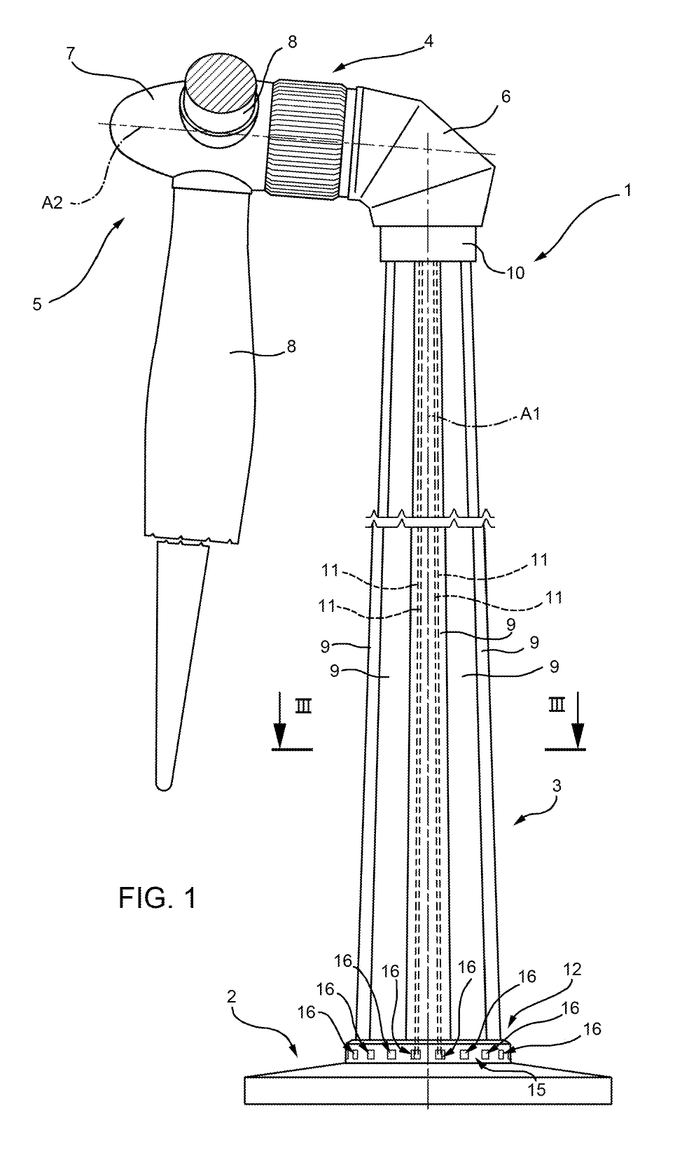

Referring now to the example embodiments of the present disclosure illustrated in FIGS. 1 to 9, number 1 in FIG. 1 indicates as a whole a wind power plant configured to produce electric energy, and which comprises a reinforced-concrete foundation 2; a pylon 3 extending along a vertical axis A1; an electric generator 4 mounted on top of pylon 3; and a blade assembly 5 configured to drive generator 4 and which rotates about an axis A2.

Generator 4 is fixed to a nacelle 6 which rotates with respect to pylon 3 about axis A1; and blade assembly 5 comprises a hub 7 integral with a rotor (not shown) of generator 4, and three blades 8, of which only two are shown in FIG. 1.

In the FIG. 1 example, pylon 3 is defined by flat, reinforced-concrete panels 9 evenly distributed about axis A1 and connected to one another; and by a ring 10 on the top end of panels 9. Panels 9 are identical, and are isosceles-trapezium-shaped so pylon 3 tapers upwards once they are assembled.

The height of each panel is greater than its mean width, and is at least three times and, in the example shown, ten times the mean width.

In the example shown, pylon 3 comprises ten identical panels 9, so it has a cross section in the form of a regular decagon tapering upwards. It should be appreciated that while the quantity of ten panels 9 arranged in a circle about axis A1 is illustrated, any suitable quantity of panels may be utilized in association with the present disclosure.

In the FIG. 1 example, the pylon is defined by one portion comprising panels 9 and ring 10, though the present disclosure also extends to embodiments (not shown) in which the pylon is defined by a portion comprising panels 9 and ring 10, and by steel portions fixed to ring 10, or is defined by a quantity of reinforced-concrete portions comprising respective panels and respective rings.

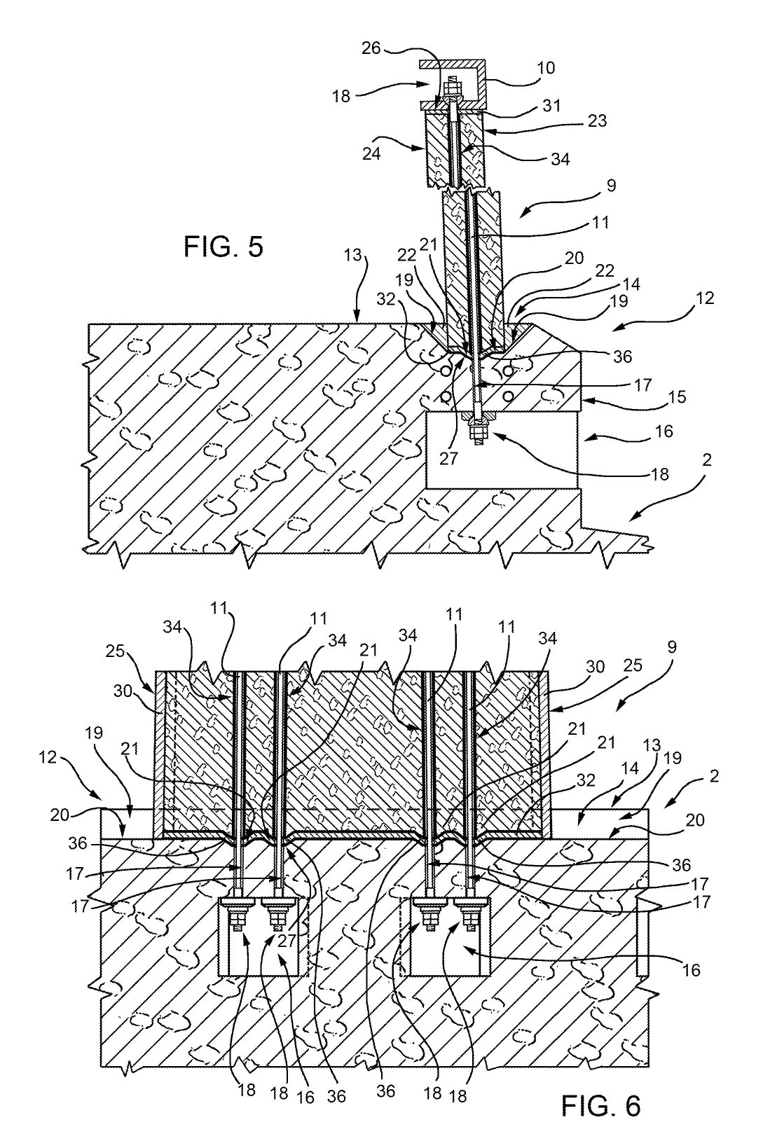

Once panels 9 are assembled to one another, each is compressed by cables 11 housed inside and extending the full height of panel 9. Cables 11 are anchored to foundation 2 and to ring 10 (as shown more clearly in FIG. 5), and serve to precompress panel 9 to enable the concrete to withstand tensile/bending stress.

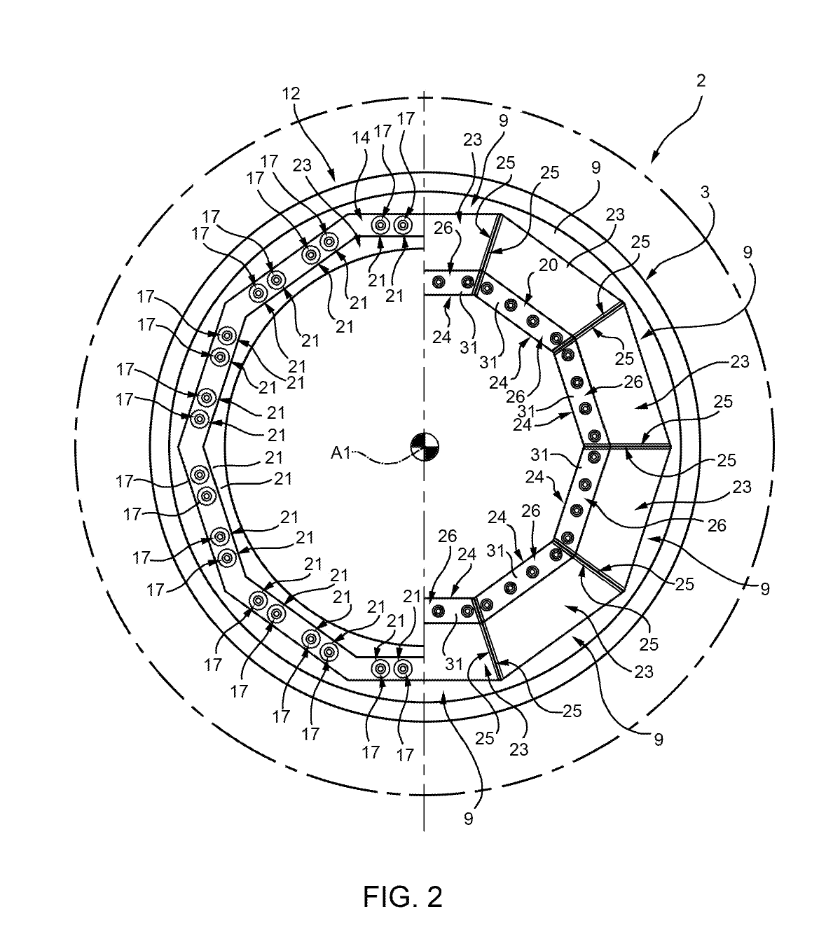

Foundation 2 comprises a platform 12 configured to support panels 9. As shown in FIG. 2, platform 12 has a top face 13; and a seat 14 (as seen in FIGS. 5 and 6) which extends about axis A1 on top face 13, and serves to house panels 9. As shown in FIG. 1, platform 12 comprises a lateral face 15, in which are formed a quantity of cavities 16 equally spaced about axis A1 in the example shown. As shown more clearly in FIGS. 5 and 6, seat 14 communicates with each cavity 16 along holes 17—in the example shown, four holes 17—through which respective cables 11 extend. Each cable 11 is anchored to foundation 2 by a terminal 18 integral with the bottom end of cable 11 and resting against a face of one of cavities 16. Similarly, each cable 11 is anchored to ring 10 by a terminal 18 integral with the top end of cable 11 and resting against a face of ring 10.

As shown in FIG. 5, seat 14 has flared lateral faces 19; and a bottom face 20, along which depressions 21 are formed at holes 17. Once panels 9 are inserted inside seat 14, the rest of seat 14 is filled with mortar 22, as shown in FIG. 5.

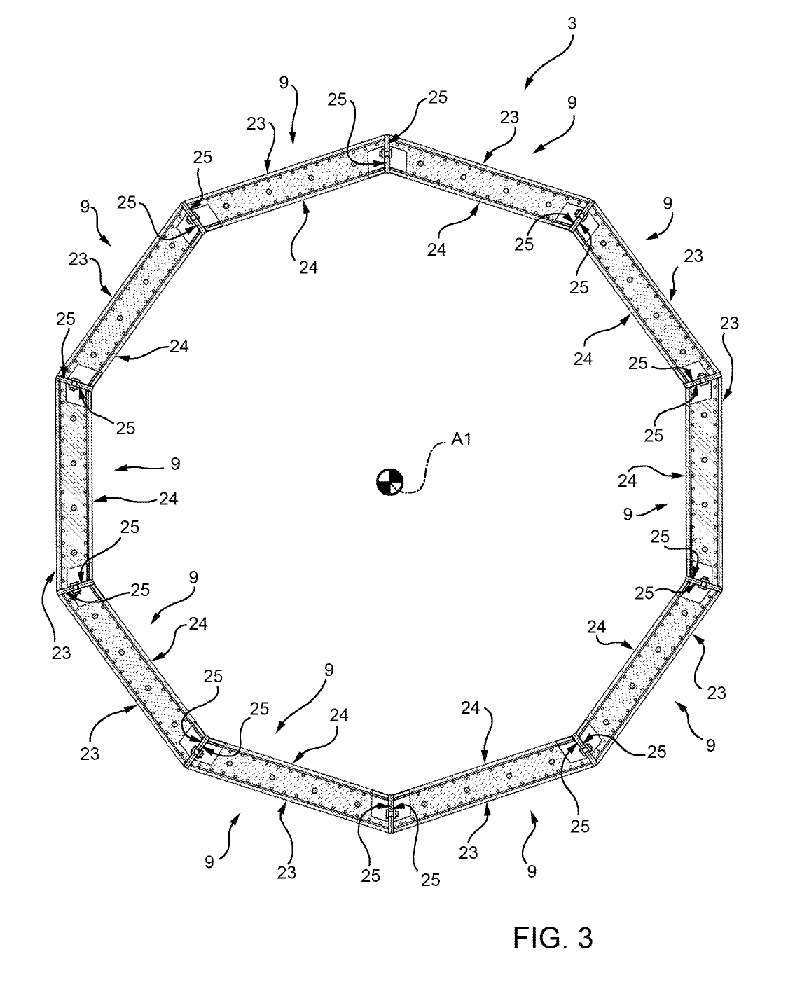

With reference to FIG. 3, each panel. 9 comprises an outer face 23; an inner face 24; two lateral faces 25; a top face 26 (on the right in FIG. 2); and a bottom face 27 (as seen in FIG. 5).

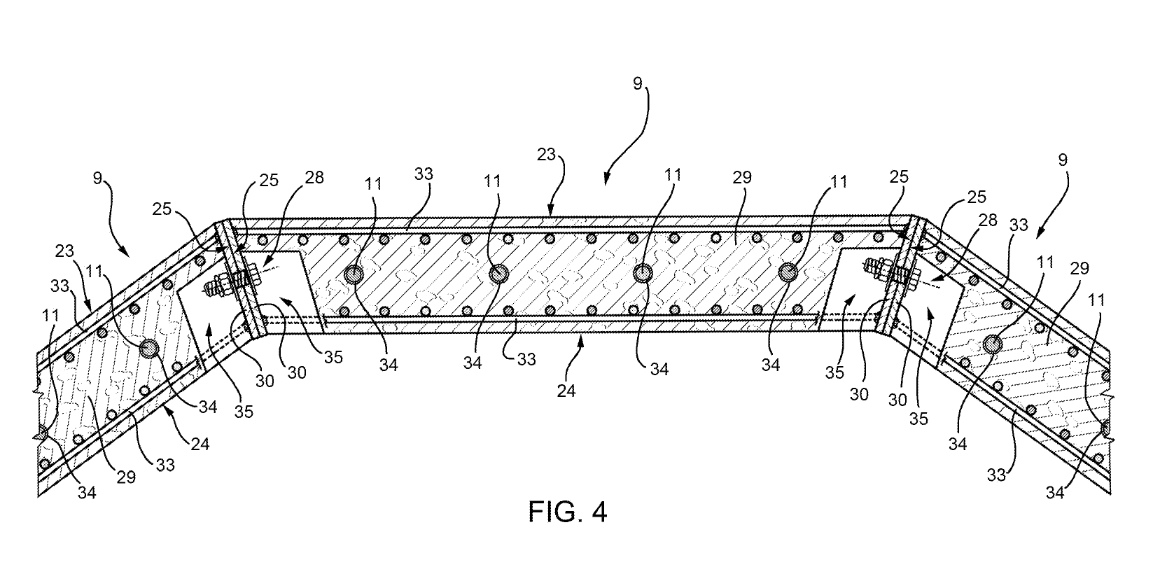

With reference to FIG. 4, panels 9 are connected to one another along lateral faces 25 by fasteners, such as fastening devices 28, which, in the example shown, are bolted joints. Each panel 9 comprises a main body 29; lateral plates 30; a top plate 31 (as seen in FIG. 2); and a bottom plate 32 (as seen in FIGS. 5 and 6). Main body 29 is made of concrete, and incorporates reinforcement 33—in the example shown, two metal mats—and four tubes 34 located between the metal mats of reinforcement 33 configured to guide cables 11 inside panel 9. Main body 29 defines outer face 23 and inner face 24, which are flat and parallel. And cavities 35 are formed along inner face 24, are partly defined by lateral plates 30, and serve to allow insertion of and access to fastening devices 28, which are inserted through lateral plates 30 of adjacent panels 9.

Lateral faces 25 extend along lateral plates 30, which have holes for fastening devices 28 to connect adjacent lateral plates 30 and, therefore, adjacent panels 9. Lateral plates 30, top plate 31, and bottom plate 32 (as seen in FIGS. 5, 6) are joined to main body 29 by fasteners (not shown) which extend inside main body 29. In one embodiment, as opposed to being joined directly to one another to form a frame, lateral plates 30, top plate 31, and bottom plate 32 are connected to one another by the main body.

With reference to FIGS. 5 and 6, bottom plate 32 has projections 36 located at the holes through which cables 11 are threaded; and projections 36 engage respective depressions 21 to position panels 9 perfectly inside seat 14.

In one embodiment, reinforcement 33 is also not connected directly to lateral plates 30, top plate 31, and bottom plate 32; and tubes 34 are connected to top plate 31 and bottom plate 32.

In one embodiment, lateral plates 30 extend along the whole of panel 9 to stiffen and enhance the flexural strength of panel 9.

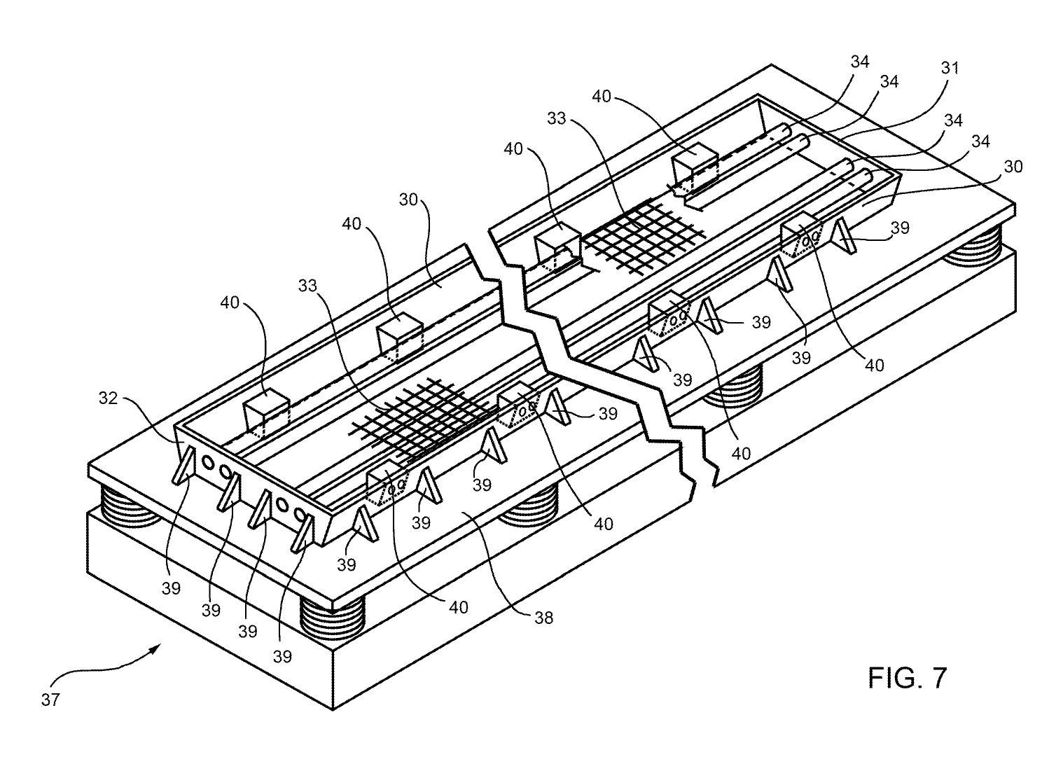

FIG. 7 shows a panel 9 during construction and positioned on a vibrating machine 37, which is used to make concrete parts and comprises a vibrating table 38, on which the molds containing cement for thickening by vibration are placed.

In the FIG. 7 example, the mold is defined by table 38, lateral plates 30, top plate 31, and bottom plate 32. Plates 30, 31, 32 are positioned to form a frame on table 38, and are kept in a more or less sloping position with respect to table 38 by adjustable sloping supports 39.

Reinforcement 33 and tubes 34 are held in position by supports (not shown in FIG. 7), while bodies 40 are positioned contacting lateral plates 30 to complete the mold. Once the mold is formed, and the reinforcement, defined by mats 33, tubes 34, and bodies 40 are positioned inside the mold, concrete is poured over the reinforcement and tubes 34, and partly around bodies 40, to form body 29.

Once the concrete is set, panel 9 is ready for assembly to foundation 2 and to other similarly made panels 9 to form pylon 3.

For relatively easy assembly and handling of panels 9, which are extremely long and subject to severe bending stress, an elongated structure 41 (as seen in FIG. 9) is used to form a cradle attachable to panel 9, and is hinged about an axis A3 parallel to the portion of seat 14 into which panel 9, supported by elongated structure 41, is inserted. Panel 9 is substantially positioned on elongated structure 41 so that, when elongated structure 41 rotates about axis A3, panel 9 is lifted into a substantially vertical position with the aid of a lifting machine (not shown) and possibly a harness 42.

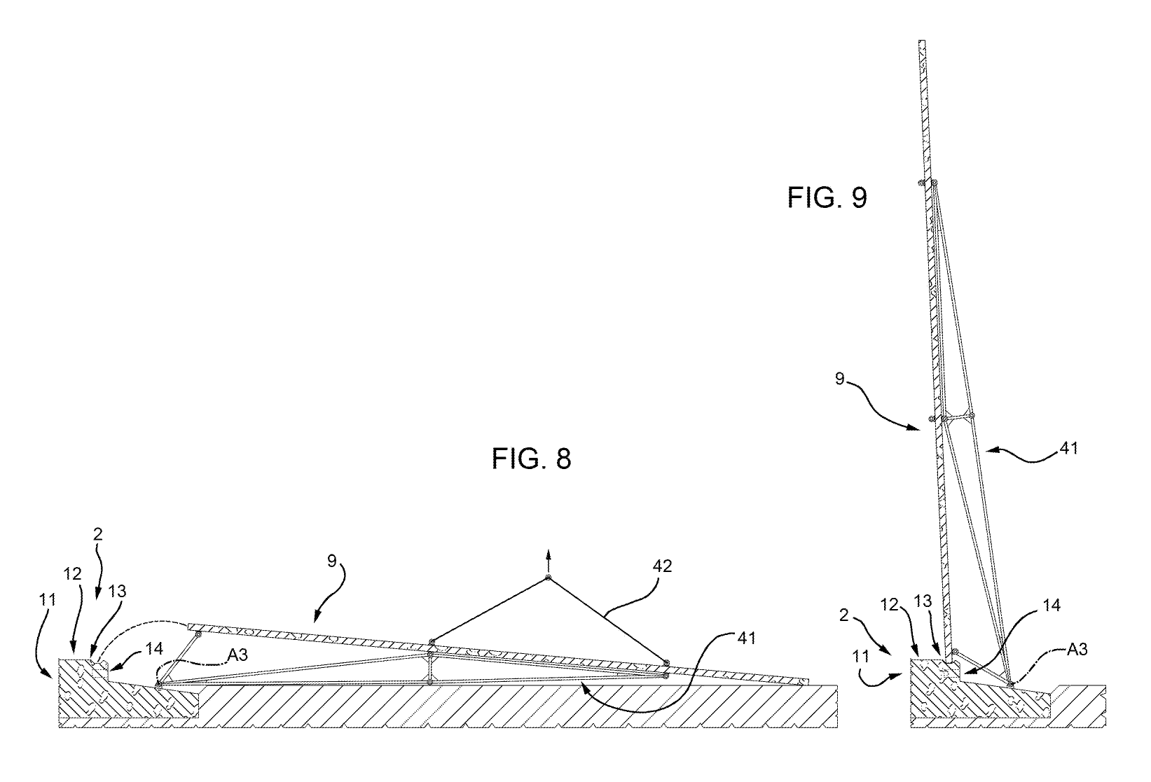

In other words, panel 9 is rotated from a substantially horizontal position (as seen in FIG. 8) to a substantially vertical position (as seen in FIG. 9) by elongated structure 41 hinged to foundation 2 and configured to house panel 9.

Scaffolding (not shown) may be erected on platform 12 to support panel 9 in a substantially vertical position and enable workers to work at different heights to connect panels 9.

Accordingly, the present disclosure provides for a simplified manufacture and assembly of the panels, and also enables relatively easy alterations to the size of the panels.

Moreover, the lateral, top and bottom plates form part of the mold, and perform designated structural functions within the finished panel.

Clearly, changes may be made to the wind power plant and method as described herein without, however, departing from the scope of the accompanying claims. It should thus be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1-13. (canceled)

14. An electric energy producing wind power plant configured to be supported by a foundation, said electric energy producing wind power plant comprising:
a pylon extending along an axis, the pylon including at least one portion made of a plurality of reinforced-concrete, adjacent panels assembled to have a polygonal cross section, wherein each panel includes an outer face, an inner face, and two lateral faces, each panel being fixed to two of the adjacent panels, and each panel includes a main body of reinforced concrete, and a plurality of lateral plates integral with the main body and at least partly defining the lateral faces of the panel;
an electric generator supported by the pylon; and
a blade assembly configured to drive the electric generator.

15. The electric energy producing wind power plant of claim 14, wherein for each panel, the lateral plates of said panel define the whole of the lateral faces of said panel.

16. The electric energy producing wind power plant of claim 14, wherein the at least one portion of the pylon is made of a plurality of identical panels.

17. The electric energy producing wind power plant of claim 14, wherein each panel is in the form of an isosceles trapezium with a height being at least three times a mean width.

18. The electric energy producing wind power plant of claim 14, wherein each panel is in the form of an isosceles trapezium with a height being at least six times a mean width.

19. The electric energy producing wind power plant of claim 14, which includes a plurality of fastening devices, each engaging a pair of contacting lateral plates of two adjacent panels.

20. The electric energy producing wind power plant of claim 19, wherein each main body of the reinforced concrete defines a plurality of cavities adjacent to the lateral plates, each cavity partly housing one of the fastening devices to fasten two adjacent lateral plates.

21. The electric energy producing wind power plant of claim 20, wherein the cavities are evenly distributed along the panel and bounded partly by one of the lateral plates.

22. The electric energy producing wind power plant of claim 14, wherein the foundation has a polygonal seat about the axis configured to house the panels.

23. The electric energy producing wind power plant of claim 22, wherein each panel includes a bottom plate defining a bottom face of the panel which is housed inside the seat.

24. The electric energy producing wind power plant of claim 23, wherein the seat has a straight portion configured to house a respective one of the panels, the straight portion of the seat and the bottom plate of the panel having respective locators configured to locate the panel with respect to the foundation.

25. The electric energy producing wind power plant of claim 24, wherein the locators include a plurality of depressions and a plurality of projections.

26. The electric energy producing wind power plant of claim 14, wherein each panel includes a top plate defining a top face of the panel.

27. The electric energy producing wind power plant of claim 14, wherein each panel is stressed by cables extending between the foundation and a top of the panel, said cables anchored to the foundation and to a ring on top of the plurality of panels.

28. The electric energy producing wind power plant of claim 14, wherein each panel of the at least one portion of adjacent panels is flat.

29. The electric energy producing wind power plant of claim 14, wherein each panel is fixed by the lateral faces to two of the adjacent panels.

30. An electric energy producing wind power plant pylon panel comprising:
a main body of reinforced concrete;
a plurality of lateral plates integral with the main body and at least partly defining two lateral faces;
an outer face; and
an inner face;
wherein said panel is configured to be fixed to at least two adjacent panels to form at least one portion of an electric energy producing wind power plant pylon extending along an axis, said at least one portion having a polygonal cross section.

31. A method of constructing a pylon of a wind power plant including a foundation, the pylon extending along an axis, an electric generator mounted on top of the pylon, and a blade assembly configured to drive the electric generator, said pylon including at least one portion made of a plurality of reinforced-concrete adjacent panels assembled to have a polygonal cross section, the method comprising:
(i) pouring concrete into a mold to at least partly form an integral part of one of said panels, the mold being defined by:
(a) a table of a vibrating machine,
(b) a plurality of lateral plates,
(c) a top plate, and
(d) a bottom plate,
wherein the lateral plates, the top plate, and the bottom plate are joined to a main body and form the integral part of the panel;
(ii) repeating (i) a plurality of times to produce said plurality of panels;
(iii) arranging said plurality of panels about the axis such that each panel is adjacent to two of the other panels; and
(iv) joining the adjacent panels.

32. The method of claim 31, wherein the mold includes a plurality of bodies adjacent to the lateral plates, the plurality of bodies defining a plurality of cavities in the panel.

33. The method of claim 31, which includes raising each panel from a substantially horizontal position to a substantially vertical position by a structure hinged to the foundation and housing said panel.

34. The method of claim 31, wherein each panel of the at least one portion of adjacent panels is flat.
